(19) United States
(12) Patent Application Publication
(10) Pub. No.: US 2006/0170816 A1
(43) Pub. Date: Aug. 3, 2006

(54) Method and system for automatically adjusting exposure parameters of an imaging device

(76) Inventors: D. Amnon Silverstein, Mountain View, CA (US); Suk Hwan Lim, San Mateo, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/045,730

(22) Filed: Jan. 28, 2005

(51) Int. Cl. H04N 5/235

(52) U.S. Cl. 348/362

(57) ABSTRACT

A method and system for automatically adjusting exposure parameters of an imaging device. Motion of the imaging device is detected using a motion sensor of the imaging device. Exposure parameter information for the imaging device is accessed. At least one exposure parameter is automatically adjusted based on a measure of the motion and the exposure parameter information.

### TECHNICAL FIELD

Embodiments of the present invention relate to the field of digital imaging. More specifically, embodiments of the present invention relate to a method and system for automatically adjusting exposure parameters of an imaging device.

### BACKGROUND ART

Digital imaging devices, such as digital cameras, allow users to take photographs and store them in digital form. In general, digital imaging devices capture images by exposing an optical sensor, such as a Charged Coupled Device (CCD), to a scene for a particular exposure time. As digital imaging technology advances, CCDs are able to capture images with greater resolution. The resolution of a digital camera refers to the number of pixels included in a captured image. For example, a three-megapixel digital camera takes an image that is divided into three million pixels. As the pixel size decreases, it is increasingly important to ensure that each pixel is exposed to a sufficient amount of light to capture the image. For instance, the exposure time may be increased to ensure that each pixel captures enough light.

Digital imaging devices also provide users with telephoto options to zoom in on a scene, enabling the capture of a closer version of the scene. As the zoom factor for capturing an image increases, the exposure time is typically proportionally shortened. However, as the pixel sizes decreases in higher resolution imaging devices, the exposure time may not be proportionally shortened, or shortened at all, to ensure that enough light is captured.

In order to account for the trade-offs between using a telephoto function and ensuring that sufficient light is captured for each pixel, a user pre-selects a particular ISO (International Organization for Standardization) setting. A low ISO setting requires more light than capturing an image at a higher ISO setting. For instance, an image captured using ISO 100 may be blurrier than the same image captured using ISO 1600. However, the ISO 1600 image would be snowier than ISO 100 image, as a result of system noise. The ISO setting is selected prior to capturing the image, and may be set by a user.

Moreover, motion blur may be caused if exposure time is lengthened, or if it is not decreased enough in the case of using a telephoto option. For instance, with a large zoom factor, even a slight tremble may cause motion blur. The telephoto functionality and insensitive pixels of digital cameras conspire to cause significant amounts of motion blur.

In a typical digital camera, a light intensity parameter is obtained prior to the intended capture. By examining the light intensity distribution and the user settings (e.g., ISO settings), the exposure parameters, including exposure time, system gain and lens aperture, are set. In particular, current digital cameras do not account for motion blur caused by imaging device movement. As pixel counts increase, combined with the use of a telephoto function, images are more likely to be blurred by motion. What is needed is a technique for automatically adjusting exposure parameters of an imaging device to reduce motion blur.

### DISCLOSURE OF THE INVENTION

Embodiments of the present invention pertain to a system and method for automatically adjusting exposure parameters of an imaging device. Motion of the imaging device is detected using a motion sensor of the imaging device. Exposure parameter information for the imaging device is accessed. At least one exposure parameter is automatically adjusted based on a measure of the motion and the exposure parameter information.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a system for automatically adjusting exposure parameters of an imaging device, in accordance with an embodiment of the present invention.

FIG. 2 is an exemplary lookup table of exposure parameter information, in accordance with an embodiment of the present invention.

FIG. 3 is a flowchart of a process for automatically adjusting exposure parameters of an imaging device, in accordance with an embodiment of the present invention.

The drawings referred to in this description should not be understood as being drawn to scale except if specifically noted.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. In other instances, well known methods, procedures, components, and circuits have not been described in detail as not to unnecessarily obscure aspects of the present invention.

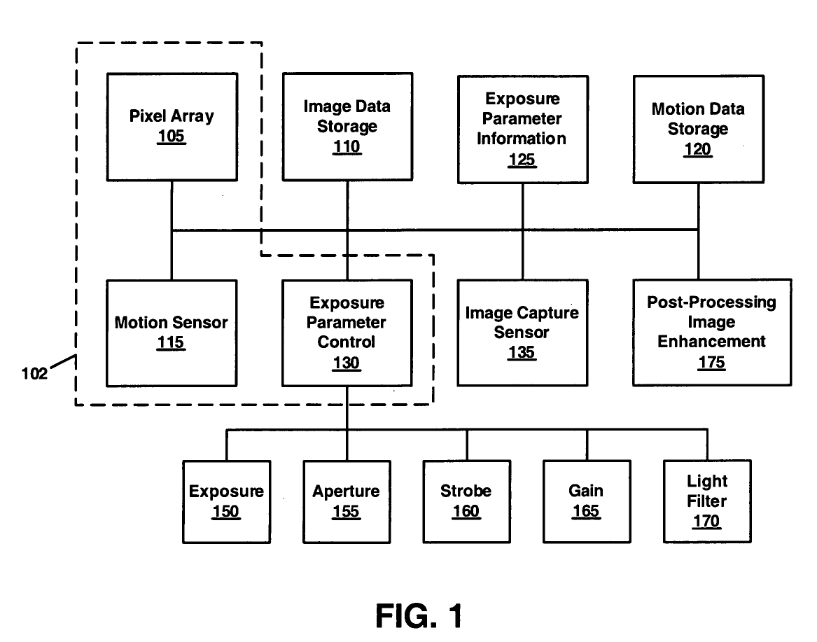

FIG. 1 is a block diagram of a system 100 for automatically adjusting exposure parameters of an imaging device, in accordance with an embodiment of the present invention. In one embodiment, system 100 is comprised within the imaging device. In one embodiment, the imaging device is a digital camera. However, it should be appreciated that the imaging device may be any electronic device that is capable of capturing images in a digital format, e.g., a digital camcorder with a still photo capture function, a cellular telephone, or a personal digital assistant (PDA).

System 100 is operable to adjust the exposure parameters of the imaging device based at least in part of the motion of the imaging device. For example, if the imaging device is at high zoom, any slight hand motion may blur the image. If hand motion is detected, a shorter exposure time may be used. Other exposure parameters, such as system gain, lens aperture, and strobe may be adjusted as well.

In one embodiment, as shown by dotted line 102, system 100 includes pixel array 105, motion sensor 115, and exposure parameter control 130. Pixel array 105 is operable to capture an image of a scene. In one embodiment, pixel array 105 is a Charge Coupled Device (CCD). However, it should be appreciated that pixel array 105 may be any image sensor for capturing image data, such as a Complementary Metal Oxide Semiconductor (CMOS) image sensor. Captured image data is stored in image data storage 110. In one embodiment, image data storage is a memory buffer.

Motion sensor 115 is operable to detect movement of the imaging device. Motion sensor 115 may be any type of sensor capable of detecting motion, including but not limited to: an accelerometer, a gyroscope, a magnetometer, an optical sensor, an angular rate sensor, or a global positioning system (GPS) circuit or other radio navigation device. In one embodiment, a detected motion data is stored as a log in motion data storage 120. In one embodiment, motion data storage 120 is a memory buffer. The motion data may be time stamped.

In one embodiment, motion sensor 115 periodically detects movement of the imaging device and stores the detected data. In another embodiment, motion sensor 115 detects movement of the imaging device when the imaging device is preparing to capture an image. In one embodiment, system 100 includes image capture sensor 135 for sensing that the imaging device is preparing to capture an image. Once image capture sensor 135 determines that the imaging device is preparing to capture an image, motion sensor 115 begins recording the motion of the imaging device. It should be appreciated that motion sensor 115 is operable to detect the movement of the imaging device at any time before, during or after the exposure.

In one embodiment, image capture sensor 135 includes an eye sensor that detects when the eyepiece of the imaging device is proximate the face or eye of a person. When the eye sensor detects the face or eye proximate the eyepiece, it is determined that the imaging device is preparing to capture an image. In another embodiment, image capture sensor 135 includes a shutter button and is able to detect when the shutter button is partially pressed. When image capture sensor 135 detects that the shutter button is partially pressed a particular amount, it is determined that the imaging device is preparing to capture an image.

Exposure parameter control 130 is operable to access exposure parameter information 125 for the imaging device. At least one exposure parameter can be automatically adjusted based on a measure of the motion and exposure parameter information 125. Exposure parameter control 130 receives the motion data from motion data storage 120 and determines the measure of motion based on the motion data. In one embodiment, the measure of motion includes a magnitude of the motion data for a particular time stamp.

Exposure parameter information 125 includes a plurality of exposure parameters that can be used to determine optimal exposure based on various input exposure parameters. In one embodiment, exposure parameter information 125 includes a lookup table that includes the plurality of exposure parameters. The lookup table may be pre-computed or pre-trained, and is accessed to select particular exposure parameters. For instance, the lookup table may be populated with data that is determined by image experts.

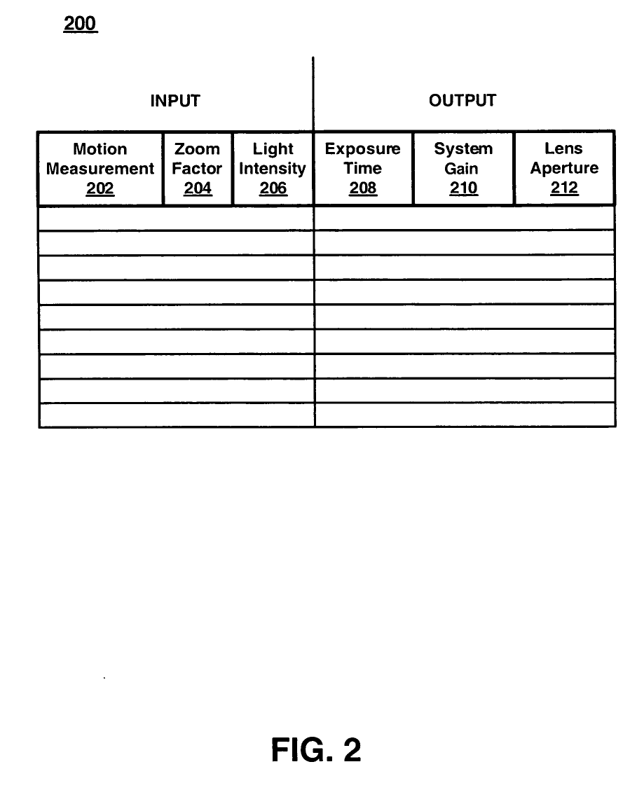

FIG. 2 is an exemplary lookup table 200 of exposure parameter information including a plurality of exposure parameters, in accordance with an embodiment of the present invention. Lookup table 200 includes the exposure parameters: motion measurement (e.g., imaging device movement) 202, zoom factor 204, light intensity 206, exposure time 208, system gain 210, and lens aperture 212. It should be appreciated that lookup table 200 is exemplary, and may include additional exposure information, such as distance to the subject.

Lookup table 200 is populated with values and/or ranges so that particular input exposure parameters can be used to adjust other exposure parameters. In one embodiment, motion measurement 202, zoom factor 204 and light intensity 206 are input exposure parameters determined automatically by the imaging device. For instance, motion measurement 202 may be measured by motion sensor 115, the user sets zoom factor 204, and light intensity may be measured by pixel array 105 or another light sensor. Other input exposure parameters, such as distance to subject, can also be determined automatically.

The input exposure parameters are then compared to corresponding values stored in lookup table 200. By comparing the input exposure values to the corresponding values in lookup table 200, the associated adjustable exposure parameters are accessed. In one embodiment, the adjustable exposure parameters are exposure time 208, system gain 210, and lens aperture 212. It should be appreciated that other exposure parameters may be adjusted, such as whether to use a flash (e.g., strobe), and whether to use a light filter.

With reference to FIG. 1, exposure parameter control 130 is operable to automatically adjust exposure parameters of the imaging device based on the movement of the imaging device and other parameters based on exposure parameter information. In one embodiment, exposure parameter control 130 is operable to adjust exposure 150, aperture 155, strobe 160, system gain 165, and light filter 170. It should be appreciated that exposure parameter control is operable to adjust the exposure parameters at any time prior to, during or after an exposure of the imaging device.

Exposure 150 adjusts the exposure time that pixel array 105 is exposed to the scene. For instance, if the imaging device is steady (e.g., no or low measure of motion), it is better to have a long exposure time with low system gain. In general, as the measure of motion increases, the exposure time of exposure 150 decreases and the system gain increases.

Aperture 155 adjusts the aperture size, and consequently the depth of field. For instance, it may be desirable to stop down the lens aperture to improve the depth of field. However, this may reduce the amount of available light. If the imaging device is steady enough, the deficit of light can be compensated by a longer exposure time. Therefore, if the measure of motion is low, it may be desirable to stop down the lens aperture.

Strobe 160 adjusts whether the flash (e.g., strobe) is used. For instance, if the imaging device is steady, it may be desirable to use a long exposure time rather than a short exposure time with the flash, since the flash uses a considerable amount of power. Furthermore, since the flash typically needs time to recharge, the imaging device may continue to captures images while the flash is recharging if the measure of motion is low.

System gain 165 adjusts the amplification of the captured image. For instance, as described above at exposure 150, if the imaging device is steady, a long exposure time may be used with low system gain. In general, as the measure of motion increases, the exposure time of exposure 150 decreases and the amplification of system gain 165 increases.

Light filter 170 adjusts whether a filter is used to remove undesirable light, such as polarized glare or infrared (IR) light. However, filtering out any light reduces the amount of available light. For instance, if the imaging device is steady enough, a filter can be used in conjunction with an increased exposure time, to compensate for the deficit light. If the imaging device is subjected to significant motion, exposure time may be decreased and light filters may not be used, to reduce motion blur.

Post-processing image enhancement 175 may be used to enhance the image after it has been captured. For instance, if a high measure of motion is detected, it may be desirable to capture an image using a short exposure time, and apply image enhancement to enhance the image. Enhancements might reduce the visibility of the motion blur, and these image enhancements may be applied if the imaging device was subjected to motion. Alternatively, other image enhancements may detrimentally affect image quality, and might be avoided if too much motion is detected. For example, edge sharpening might primarily amplify noise if the image has too much motion blur.

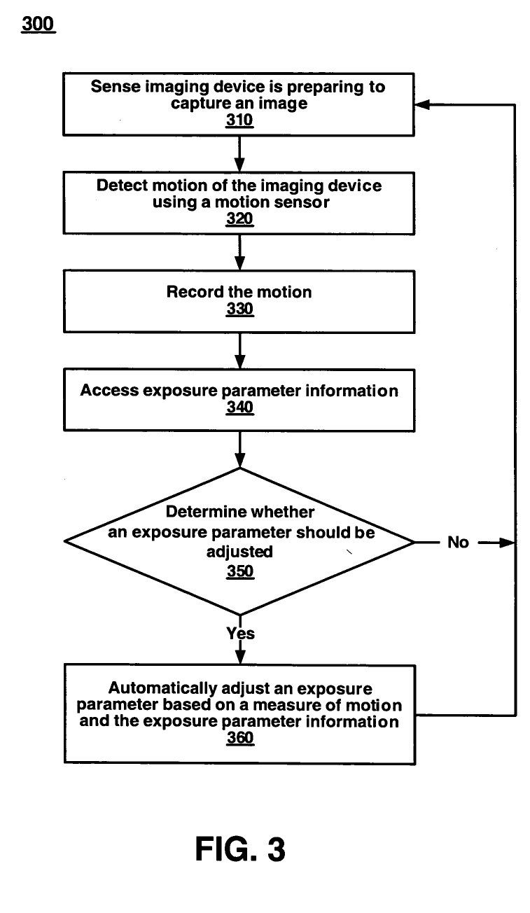

FIG. 3 is a flowchart of a method 300 for automatically adjusting exposure parameters of an imaging device, in accordance with an embodiment of the present invention. In one embodiment, method 300 is carried out by a processor under the control of computer-readable and computer-executable instructions. The computer-readable and computer-executable instructions reside, for example, in data storage features such as computer usable volatile memory, computer usable non-volatile memory, and/or a data storage device of an imaging device. Although specific steps are disclosed in method 300, such steps are exemplary. That is, the embodiments of the present invention are well suited to performing various other steps or variations of the steps recited in FIG. 3.

At step 310 of method 300, it is sensed that the imaging device is preparing to capture an image. In one embodiment, an image capture sensor (e.g., image capture sensor 135 of FIG. 1) senses that the imaging device is preparing to capture an image. In one embodiment, the sensing is performed using an eye sensor of the imaging device, wherein the imaging device is preparing to capture an image if the eye sensor detects that the imaging device is in close proximity to an eye of a person. In another embodiment, the sensing is performed using a shutter button of the imaging device, wherein the imaging device is preparing to capture an image if the shutter button is partially pressed. It should be appreciated that step 310 is optional, and that method 300 may begin at step 320.

At step 320, motion of the imaging device is detected using a motion sensor (e.g., motion sensor 115 of FIG. 1). At step 330, the motion is recorded. It should be appreciated that the motion may be recorded at any time prior to, during or after an exposure of the imaging device. In one embodiment, the motion data is stored as a log (e.g., at motion data storage 120 of FIG. 1). In one embodiment, steps 320 and 330 are initiated in response to sensing that the imaging device is preparing to capture an image, as described at step 310. It should be appreciated that step 330 is optional.

At step 340, the exposure parameter information for the imaging device is accessed. In one embodiment, the exposure parameter information includes a lookup table (e.g., lookup table 200 of FIG. 2) for storing a plurality of the exposure parameters. The plurality of exposure parameters includes, but is not limited to: imaging device movement, zoom factor, light intensity, distance to subject, exposure time, system gain, lens aperture, strobe, and light filtering.

At step 350, it is determined whether an exposure parameter should be adjusted. In one embodiment, this determination is made based on a measure of the motion data and the exposure parameter information. In one embodiment, the measure of the motion includes a magnitude of the motion. For example, it may be determined that the imaging device has moved by an angle where the trade off between noise amplification and motion blur are equal. That is, if the exposure is continued, the picture will have mainly objectionable motion blur. To get the best picture the exposure is ended at this point and the underexposed image may be enhanced with more amplification. If it is determined that no exposure parameter should be adjusted, method 300 returns to optional step 310 or step 320. Alternatively, if it is determine that an exposure parameter should be adjusted, method 300 proceeds to step 360.

At step 360, at least one exposure parameter is automatically adjusted based on a measure of the motion and the exposure parameter information. In one embodiment, the exposure parameter information corresponding to the measure of motion is accessed, and at least one exposure parameter is automatically adjusted based on the exposure parameter information corresponding to the measure of motion. In one embodiment, the exposure parameter is automatically adjusted prior to the exposure. In another embodiment, the exposure parameter is automatically adjusted during the exposure, e.g., the exposure is ended early to reduce objectionable motion blur. In another embodiment, the exposure parameter is automatically adjusted after the exposure, e.g., the user may be prompted to take the picture again with the new exposure parameters.

In summary, in its various embodiments, the present invention provides for automatically adjusting exposure parameters of an imaging device based at least in part on motion of the imaging device. In general, movement of the imaging device is detrimental to image quality since it blurs the image. A motion sensor detects the amount of motion prior to or during image capture. The motion data can then be used to adjust various exposure parameters, such as the maximum exposure time, the system gain, the size of the lens aperture opening, or whether to use the strobe.

Various embodiments of the present invention, a method and system for automatically adjusting exposure parameters of an imaging device, are described herein. While the present invention has been described in particular embodiments, it should be appreciated that the present invention should not be construed as limited by such embodiments, but rather construed according to the following claims.

What is claimed is:

1. A method for automatically adjusting exposure parameters of an imaging device, said method comprising:
detecting motion of said imaging device using a motion sensor of said imaging device;
accessing exposure parameter information for said imaging device; and
automatically adjusting at least one exposure parameter based on a measure of said motion and said exposure parameter information.

2. The method as recited in claim 1 wherein said measure of said motion comprises a magnitude of said motion.

3. The method as recited in claim 1 wherein said detecting motion of said imaging device using said motion sensor comprises:
sensing said imaging device is preparing to capture an image; and
recording said motion in response to said sensing.

4. The method as recited in claim 3 wherein said sensing is performed using an eye sensor of said imaging device, wherein said imaging device is preparing to capture an image if said eye sensor detects that said imaging device is in close proximity to an eye of a person.

5. The method as recited in claim 3 wherein said sensing is performed using a shutter button of said imaging device, wherein said imaging device is preparing to capture an image if said shutter button is partially pressed.

6. The method as recited in claim 1 wherein said detecting motion of said imaging device using said motion sensor comprises recording said motion during an exposure of said imaging device.

7. The method as recited in claim 1 wherein said exposure parameter information comprises a lookup table for storing a plurality of said exposure parameters.

8. The method as recited in claim 7 wherein said plurality of said exposure parameters is selected from a group consisting of: imaging device movement, zoom factor, light intensity, exposure time, system gain, and lens aperture.

9. The method as recited in claim 1 wherein said automatically adjusting at least one exposure parameter based on a measure of said motion and said exposure parameter information comprises:
accessing said exposure parameter information corresponding to said measure of motion; and
automatically adjusting at least one said exposure parameter based on said exposure parameter information corresponding to said measure of motion.

10. The method as recited in claim 1 wherein said imaging device is a digital camera.

11. An imaging device comprising:
a pixel array for capturing an image;
a motion sensor for detecting motion of said imaging device;
an exposure parameter control for accessing exposure parameter information for said imaging device and for automatically adjusting at least one exposure parameter based on a measure of said motion and said exposure parameter information.

12. The imaging device as recited in claim 11 wherein said measure of said motion comprises a magnitude of said motion.

13. The imaging device as recited in claim 11 further comprising an image capture sensor for sensing said imaging device is preparing to capture an image, wherein said motion sensor is operable to detect said motion in response to said sensing said imaging device is preparing to capture said image.

14. The imaging device as recited in claim 13 wherein said image capture sensor comprises an eye sensor, wherein said imaging device is preparing to capture an image if said eye sensor detects that said imaging device is in close proximity to an eye of a person.

15. The imaging device as recited in claim 13 wherein said image capture sensor comprises a shutter button, wherein said imaging device is preparing to capture an image if said shutter button is partially pressed.

16. The imaging device as recited in claim 11 further comprising motion data storage, wherein said motion is recorded and stored in said motion data storage.

17. The imaging device as recited in claim 11 wherein said exposure parameter information comprises a lookup table including a plurality of said exposure parameters.

18. The imaging device as recited in claim 17 wherein said plurality of said exposure parameters is selected from a group consisting of: imaging device movement, zoom factor, light intensity, exposure time, system gain, and lens aperture.

19. The imaging device as recited in claim 11 wherein said exposure parameter control is operable to automatically adjusting at least one exposure parameter by accessing said exposure parameter information corresponding to said measure of motion and automatically adjusting at least one said exposure parameter based on said exposure parameter information corresponding to said measure of motion.

20. The imaging device as recited in claim 11 wherein said imaging device is a digital camera.

21. A computer-usable medium having computer-readable program code embodied therein for causing a computer system to perform a method for automatically adjusting exposure parameters of an imaging device, said method comprising:
detecting motion of said imaging device using a motion sensor of said imaging device;
accessing exposure parameter information for said imaging device; and
automatically adjusting at least one exposure parameter based on a measure of said motion and said exposure parameter information.

22. The computer-usable medium as recited in claim 21 wherein said measure of said motion comprises a magnitude of said motion.

23. The computer-usable medium as recited in claim 21 wherein said detecting motion of said imaging device using said motion sensor comprises:
sensing said imaging device is preparing to capture an image; and
recording said motion in response to said sensing.

24. The computer-usable medium as recited in claim 21 wherein said detecting motion of said imaging device using said motion sensor comprises recording said motion during an exposure of said imaging device.

25. The computer-usable medium as recited in claim 21 wherein said exposure parameter information comprises a lookup table for storing a plurality of said exposure parameters.

26. The computer-usable medium as recited in claim 21 wherein said automatically adjusting at least one exposure parameter based on a measure of said motion and said exposure parameter information comprises:
accessing said exposure parameter information corresponding to said measure of motion; and
automatically adjusting at least one said exposure parameter based on said exposure parameter information corresponding to said measure of motion.

27. The computer-usable medium as recited in claim 21 wherein said imaging device is a digital camera.

28. An imaging system comprising:
means for capturing an image;
means for detecting motion of said imaging system; and
means for accessing exposure parameter information for said imaging system and for automatically adjusting at least one exposure parameter based on a measure of said motion and said exposure parameter information.
